(19) United States
(12) Patent Application Publication
(10) Pub. No.: US 2019/0360460 A1
(43) Pub. Date: Nov. 28, 2019

(54) Method for Rotating the Rotor of a Wind Turbine

(71) Applicant: SENVION GmbH, Hamburg (DE)

(72) Inventor: Roland Fischer, Rantrum (DE)

(21) Appl. No.: 16/479,374

(22) PCT Filed: Jan. 19, 2018
(86) PCT No.: PCT/EP2018/051256

§ 371 Date: Jul. 19, 2019

(30) Foreign Application Priority Data
Jan. 19, 2017 (DE) 10 2017 000 435.8

(51) Int. Cl. F03D 7/02

(52) U.S. Cl. CPC F03D 7/024; F03D 80/50; F03D 7/0244; F03D 7/0224

(57) ABSTRACT

A method for rotating the rotor of a wind turbine, in particular in still air conditions. The rotor rotates about a rotor axis and comprises at least three rotor blades, each having a center of gravity located outside of the respective axes of rotation. To create an imbalance in the rotor, the blade pitch angle of a first rotor blade is systematically set to be different from the blade pitch angle of a second rotor blade in such a way that a gravitational torque about the rotor axis is generated as a result of the change in the position of the center of gravity of the first rotor blade. The invention also relates to a computer program product and a wind turbine, which are designed to carry out this method.

### BACKGROUND

The invention relates to a method for rotating the rotor of a wind turbine, in particular in still air conditions.

Wind turbines are known from the state of the art. They usually include a rotor, which is rotatably disposed on a gondola, wherein the gondola is in turn rotatably disposed on a tower. The rotor may drive a generator via a rotor shaft and a gearbox. A wind-induced rotational movement of the rotor can thus be converted into electrical energy, which can then be fed into an electricity grid via inverters and/or transformers—depending on the design of the generator at least partly directly. The rotor comprises several (usually three), rotor blades extending essentially radially from the rotor axis, which are rotatably mounted relative to a rotor hub to adjust the angle of attack of the rotor blades.

During various maintenance and repair work on a wind turbine, the rotor must be moved to a predetermined position and locked there. If there is sufficient wind, the rotor blades of the wind turbine can be turned into the wind in such a way that the rotor rotates and is stopped in the desired position by a brake. The brake can subsequently remain applied and thus achieve the desired retention. However, it is also possible to provide a separate locking device. A suitable device is disclosed in WO 2005/090780 A1, for example.

However, in order not to be necessarily dependent on sufficient wind for locking the rotor in a certain position, there is a need to turn the rotor of a wind turbine even in the case of still wind conditions or only slight wind that is insufficient to drive the rotor.

In the state of the art, so-called yaw drives are known, which can exert a torque on the shaft of the rotor if necessary, in order to rotate the rotor. The yaw drives can be permanently installed in the wind turbine or designed as mobile devices that are only connected to the shaft of the wind turbine if necessary. However, yaw drives are expensive and, in particular, as a mobile device, some of them are so impractical that they are not always used by fitters, even if this would be generally appropriate.

Instead of using a drive, it is often attempted to turn the rotor by hand. The brake disc of the rotor brake is gripped and pulled in a tangential direction. To move the rotor of a wind turbine in a sufficient rotational motion, however, is very strenuous and also extremely dangerous.

It is an object of the present invention to provide a method for rotating the rotor of a wind turbine, in particular in the case of still wind conditions, in which the disadvantages of the prior art no longer occur or only to a reduced extent.

### SUMMARY OF THE INVENTION

Therefore, the invention relates to a method for rotating the rotor of a wind turbine with a rotor that is rotatable about a rotor axis comprising at least three rotor blades, the center of gravity of each of which is outside the axis of rotation to adjust the blade pitch angles of the individual rotor blades, wherein the blade pitch angle of a first rotor blade is systematically set differently from the blade pitch angle of a second rotor blade to produce an imbalance in the rotor that produces a gravitational torque about the rotor axis by changing the position of the center of gravity of the first rotor blade.

Furthermore, the invention relates to a computer program product comprising program parts, which are designed to perform the method according to the invention when loaded in a computer, preferably the control unit of a wind turbine.

The invention also concerns a wind turbine with a rotor that is rotatable about a rotor axis comprising at least three rotor blades, the center of gravity of each of which is outside the axis of rotation to adjust the blade pitch angle of the individual rotor blades, and a control unit, wherein the control unit is embodied to carry out the method according to the invention.

First, some terms used in connection with the invention are explained.

The term “gravitational torque” denotes the torque acting on the rotor about the rotor axis, which results solely from the sum of the torques acting on the rotor based on the weight forces of the rotor blades. Thus, only the torques on the rotor generated by the mass of the rotor blades are to be taken into account, while other torques, for example due to wind, are not to be taken into account in the gravitational torque.

The term “rotor angle” refers to the current rotation angle of the rotor about the rotor axis relative to a predetermined 0° position. Frequently, a position of the rotor is chosen as the 0° position, in which one of the rotor blades disposed there is oriented vertically upwards. This rotor blade may be the first rotor blade, for example.

The “breakaway torque” is the torque that has to be used for a rotational movement in order to overcome the static friction that exists when at a standstill.

The invention has recognized that in a rotor that is substantially balanced in normal operation, in which all rotor blades are set to the same blade pitch angle, an imbalance can be produced by an unequal blade pitch angle between individual rotor blades, which ultimately leads to a rotational movement of the rotor. The invention makes use of the fact that the center of gravity of a rotor blade is usually not on the axis about which it is rotated to adjust the blade pitch angle, but is spaced apart therefrom. Ultimately, by a rotation of the rotor blade about this axis, the lever arm between the center of gravity of the rotor blade and the rotor axis can be changed, whereby the torque exerted on the rotor also changes due to the mass of the rotor blade. Surprisingly, it has been shown that the actually low center of gravity eccentricity in today's wind turbines can be sufficient to overcome a minimum required breakaway torque due to the frictional forces in the drive train. It is preferred if the change in the blade pitch angle of the first rotor blade or of all rotor blades is carried out in such a way that the resulting gravitational torque is sufficient to overcome an existing breakaway torque due to the frictional forces in the drive train.

For example, starting from a rotor at rest in torque equilibrium, in which the rotor blades all have the same blade pitch angle, by adjusting different blade pitch angles and the associated change in the center of gravity position of the individual rotor blades an imbalance is produced and thus a gravitational torque about the rotor axis is generated that is greater than the breakaway torque and ultimately leads to a rotational acceleration of the rotor. This allows the rotor of the wind turbine to be rotated without the need for externally applied forces due to wind, a yaw drive or the muscle power of a fitter.

The blade pitch angle at least of the first rotor blade is preferably changed depending on the rotor angle such that the torque resulting from the imbalance produced in this way acts in a predetermined direction about the rotor axis. If the blade pitch angle of the first rotor blade is set differently compared to a second rotor blade, a torque and from this a rotational movement of the rotor results as explained. With this rotational movement, however, the position of the rotor blades relative to the rotor axis changes and thus the torques applied by the mass of the rotor blades to the rotor axis changes as well as the resulting gravitational torque. If the blade pitch angle of the rotor blades remained unchanged after an initial adjustment with such a rotation, the rotational movement would come to a standstill if the total center of gravity of the rotor has moved below the rotor axis or a pendulum oscillation of the rotor about the rotor axis would occur due to the constant static imbalance. By systematically changing the blade pitch angle at least of the first rotor blade but depending on the rotor angle and thus the position of the respective rotor blade, it is possible that the resulting gravitational torque acts permanently in one direction about the rotor axis. The change of the blade pitch angle at least of the first rotor blade depending on the rotor angle can be represented by a mathematical function or by a characteristic curve.

It is preferred if in particular in a rotor at rest the axis of rotation for adjusting the blade pitch angle of the first rotor blade for generating an imbalance differs from the horizontal by at least 5°, preferably by at least 10°, more preferably by at least 20°. For the generation of a torque by the center of gravity displacement caused by means of a rotation of the first rotor blade for setting the blade pitch angle, only its projection onto a plane perpendicular to the rotor axis is relevant. In this plane, the center of gravity shift takes place only perpendicularly to the axis of rotation of the rotor blade. If this axis of rotation is essentially horizontal or almost horizontal, a change in the blade pitch angle of this rotor blade results in no or only a small change in torque. In this case, it is preferable if another rotor blade of the rotor is the first rotor blade in the sense of the invention. As already indicated, this is especially true in the case of a dormant rotor, which is to be rotated only by the generation according to the invention of an imbalance. If there is already a rotational movement, on the other hand the first rotor blade can easily perform a pass through a horizontal position, in which, although as a rule no additional torque is exerted on the rotor by this rotor blade, nevertheless the first rotor blade can again generate a corresponding torque on the rotor after the pass through the horizontal position.

It is preferred if the blade pitch angles of at least two, preferably of all rotor blades are changed as a function of the rotor angle so that the imbalance of the rotor is increased compared to the change of the blade pitch angle of only one rotor blade. In other words, the blade pitch angles of all rotor blades should be adjusted as a function of the rotor angle in such a way that a larger resulting gravitational torque is produced due to the respective displacements of the centers of gravity of the individual rotor blades. Thus, for example, by appropriate rotation of individual rotor blades, the respective lever arm can be extended, if in doing so the torque acting on the rotor axis is in the predetermined direction of the desired resulting torque, while the lever arm is reduced in those rotor blades that apply a torque to the rotor against the predetermined direction of the desired resulting torque.

The method according to the invention can be used in particular to move the rotor into a predetermined angular position, in which the rotor can then be locked, for example. To enable this, the rotor angle is preferably monitored and the imbalance in the rotor is reduced or eliminated even before, but at the latest on reaching the predetermined angular position. As a result, the gravitational torque acting on the rotor is reduced or completely eliminated, whereupon the rotor brakes at least due to friction losses and can finally come to a standstill. Even if the rotor can in principle be brought into a desired angular position by suitable control of the imbalance alone, it is preferred if the rotor is additionally or alternatively stopped in the predetermined angular position by a brake. By using a brake, a relatively accurate stop of the rotor in the given angular position is possible. The brake may, for example, be a brake intended for emergency stopping of a wind turbine. The brake can also be used to fix the wind turbine in the specified angular position. Alternatively or additionally, of course, a separate locking device may also be provided.

The method is particularly suitable for rotating the rotor of a wind turbine in the event of still wind conditions. If wind prevails, it can be used to rotate the rotor, as is known in the state of the art. It is therefore preferred if the wind speed at the wind turbine is monitored in advance—i.e. before the angle of attack of the first rotor blade is changed—and/or during the execution of the process—and the process is terminated at wind speeds above 2 m/s, preferably above 1 m/s, more preferably above 0.5 m/s. This also ensures, among other things, that no undesirable and possibly unforeseen forces could act on the rotor and the wind turbine that are caused by the different angles of attack of the individual rotor blades due to the wind that impinges thereon.

Preferably, the rotor rotation speed or the rotor speed about the rotor axis is monitored before and/or during the execution of the process, wherein the process is aborted on exceeding a predetermined maximum speed. The imbalance generated according to the invention in combination with an excessive rotational speed of the rotor leading to undesirable vibrations in the wind turbine is avoided with suitable monitoring.

To eliminate the imbalance and/or to terminate the process, the angles of attack of the rotor blades can be set identical to each other. If all rotor blades have identical angles of attack, the rotor is usually balanced. It is particularly preferred when the rotor blades are moved into the feathered position, so that also no torque induced by wind that may possibly occur can act on the rotor.

The adjustment of the blade pitch angles of the individual rotor blades is preferably carried out by electric blade adjustment drives. Compared to hydraulic blade adjustment drives, for example, electric blade adjustment drives offer a blade angle range of +/−90° starting from the normal operating position (the 0° position) or from 0° to 180° from the feathered position, which is advantageous for the generation of an imbalance provided according to the invention, especially when the rotor is rotating.

Even if the center of gravity position provided according to the invention outside the rotary axes for adjusting the blade pitch angle can be achieved for a rotor blade by various measures up to the application of additional ballast weights at selected points of the rotor blade, it is preferred if the rotor blades are pre-curved rotor blades. It has been shown that suitably pre-curved rotor blades, the bending of which is originally intended to ensure the free movement of the rotor blades in front of the tower of the wind turbine, already regularly have sufficient distance between the axis of rotation and the center of gravity for the method according to the invention.

For the description of the computer program product according to the invention as well as the wind turbine according to the invention, reference is made to the above explanations.

### BRIEF DESCRIPTION OF THE DRAWINGS

The invention is now further explained on the basis of an advantageous embodiment with reference to the attached drawings. In the figures:

FIG. 1: shows a schematic representation of a wind turbine according to the invention;

FIG. 2: shows a schematic representation of the gondola of the wind turbine from FIG. 1;

FIG. 3: shows a front view of the rotor of the wind turbine according to FIGS. 1 and 2 in the balanced state;

FIG. 4: shows a front view of the rotor of the wind turbine according to FIGS. 1 and 2 with an imbalance produced according to the invention;

FIG. 5: shows a schematic representation of the dependence of the torque induced by a rotor blade on the blade pitch angle using the example of the wind turbine from FIGS. 1 and 2;

FIG. 6: shows a schematic representation of the dependence of the blade pitch angle of a rotor blade on the rotor angle using the example of the wind turbine from FIGS. 1 and 2; and

FIG. 7: shows a diagram of the generation according to the invention of a gravitational torque using the example of the wind turbine from FIGS. 1 and 2.

### DETAILED DESCRIPTION

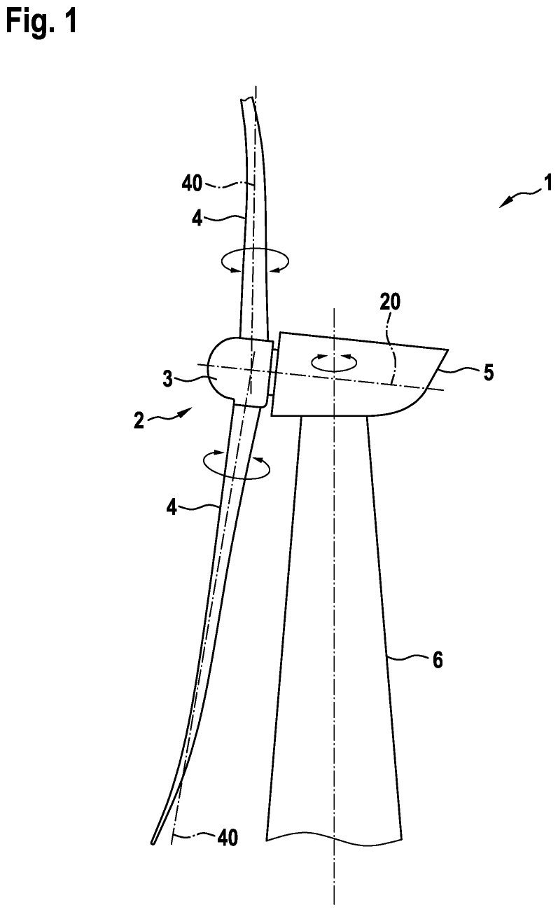

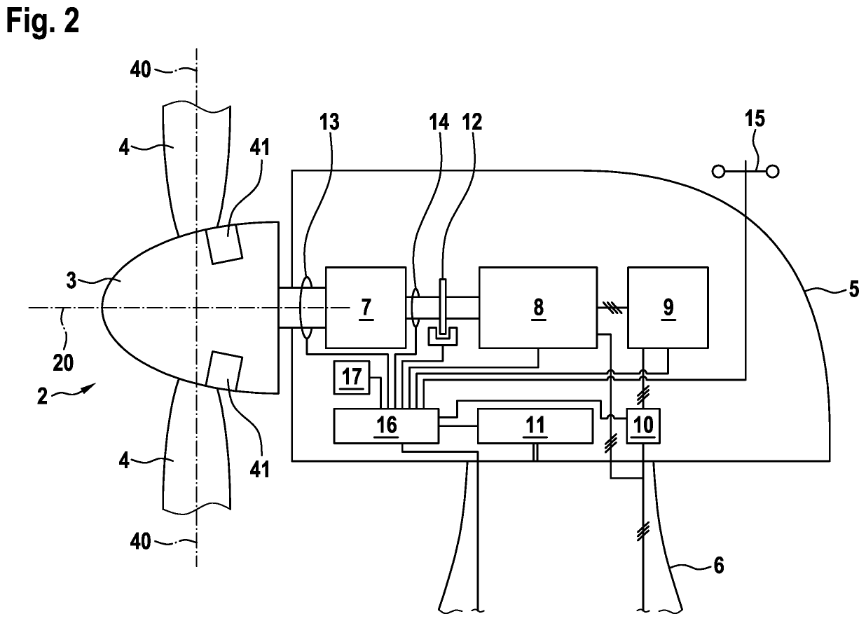

A wind turbine 1 and its gondola 5 according to the invention and thus designed for carrying out the method according to the invention are schematically represented in FIGS. 1 and 2. The wind turbine 1 comprises a rotor 2 with a total of three rotor blades 4 attached to a rotor hub 3. The rotor 2 is disposed on the gondola 5 so as to be rotatable about a rotor axis 20, wherein the gondola 5 is in turn disposed on a tower 6 so as to be rotatable about a vertical axis by means of an azimuth drive 11.

The rotor hub 3 is connected by means of a gearbox 7 to a generator 8 for the conversion of wind energy acting on the rotor 2 into electrical energy. The generator 8 is a dual-fed asynchronous generator in which one part of the generated power is passed directly and another part of the power is passed via an inverter 9 and a switching element 10 to a transformer located at the base of the tower 6 (not shown) and from there is fed into a public supply network.

Furthermore, between the gearbox 7 and the generator 8, a brake 12 is provided with which a rotational movement of the rotor 2 about the rotor axis 20 can be braked and the rotor 2 can be locked. In addition, there is a device 13 for determining the current rotor angle, a device 14 for determining the rotor speed (or the speed of the shaft between the gearbox 7 and the generator 8, which directly correlates with the rotor speed), and a device 15 for determining the wind speed in the vicinity of the gondola 5 and the rotor 2.

The components 7-11 disposed in the gondola 5 of the wind turbine 1 that can be controlled or monitored, as well as all sensors 13, 14, 15, are connected to a control unit 16 that controls the operation of the wind turbine 1. The control unit 16 is programmable and includes a memory 17 in which control programs can be stored.

As can be seen in FIG. 1, the rotor blades 4 of the rotor 2 are pre-curved, so that even in strong winds free passage of the rotor blades 4 in front of the turret 6 is guaranteed. Furthermore, the rotor blades 4 are each adjustable about an axis of rotation 40 with respect to their respective angles of attack. To adjust the blade pitch angle, an electric blade adjustment actuator 41 is disposed in the rotor hub 3. Said blade adjustment actuators 41 are also controlled by the control device 16 via control lines that are not shown for reasons of clarity. From the state of the art, sufficient methods for operating the wind turbine are known, in which the angle of attack of the rotor blades is changed in order to obtain the best possible power generation in different wind conditions.

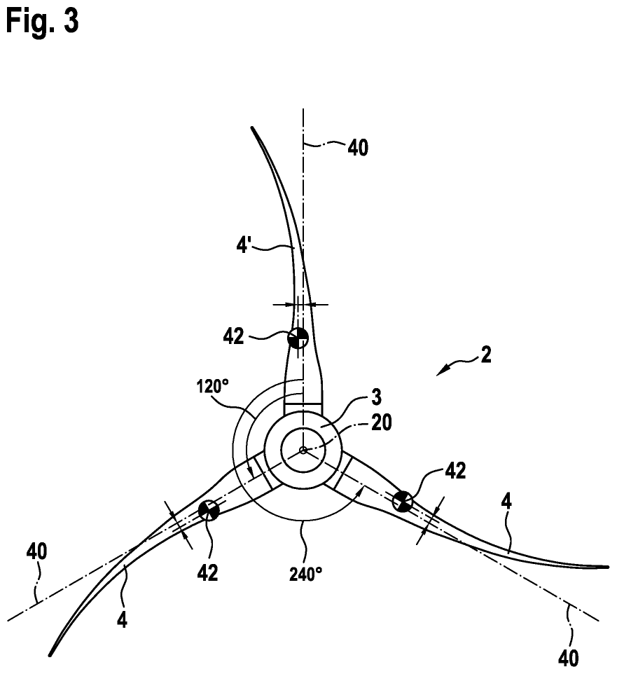

In FIG. 3 a front view of the rotor 2 of the wind turbine 1 from FIGS. 1 and 2 is shown, wherein the representation of the gondola 5 and the tower 6 was omitted for reasons of clarity. The three rotor blades 4 all have a blade pitch angle of 90°, so they are in the feathered position. A rotor blade 4—namely the first rotor blade 4′—points vertically upwards, which corresponds here to a rotor angle of 0°. As a result, the other rotor blades 4 are at 120° and 240°.

The rotor blades 4 each have a mass of 8000 kg, wherein the center of gravity 42 of each of the rotor blades 4 is 20 cm outside the respective axis of rotation 40. In the 90° position shown in FIG. 3, the distance between the center of gravity 42 and the axis of rotation 40 in the plane relevant to the rotor axis 20 running perpendicularly to the plane of the blade—namely the plane of the blade—is just 20 cm. As a result, respective torques act due to the mass of the rotor blades 4, but are always in equilibrium if the three rotor blades 4 are at the same blade angle setting. Thus, the counterclockwise torques of the first rotor blade 4′ and the rotor blade 4 at 120° are compensated by the torque of the rotor blade 4 at 240°. The rotor 2 is therefore balanced. It should be noted that the rotor 2 is balanced independently of the rotor angle if all rotor blades 4 have the same blade pitch angle.

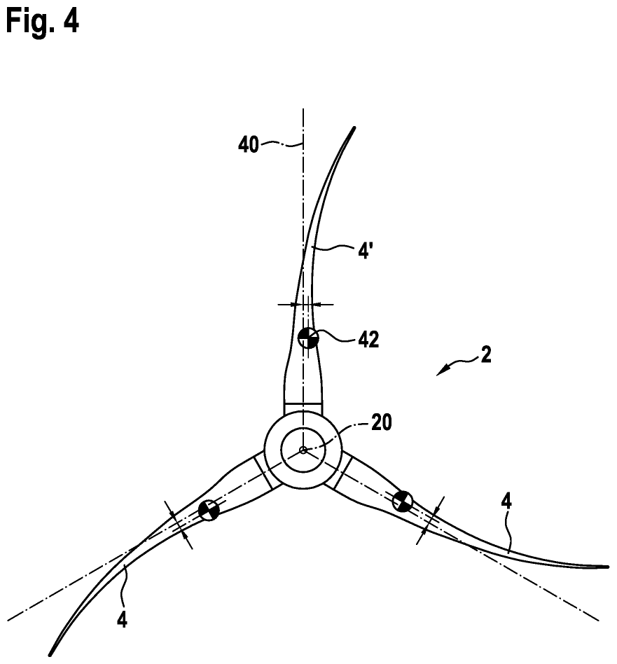

The rotor 2 from FIG. 3 is shown in FIG. 4, but the blade pitch angle of the first rotor blade 4′ is set differently compared to the blade pitch angle of a second rotor blade—that is, one of the other two rotor blades 4. The blade pitch angle of the first rotor blade 4′ is −90° in this case (the so-called negative feathered position), so that the center of gravity 42 of the first rotor blade 40 is now at a distance of 20 cm on the other side of the axis of rotation 40.

Due to the adjustment of the blade angle of the first rotor blade 4′ shown in FIG. 4, the torque applied to the rotor 2 by said rotor blade 4′ changes, while the torques caused by the other rotor blades 4 have remained unchanged compared to FIG. 3. In particular, the direction of rotation of the torque induced by the first rotor blade 4′ changes. This torque no longer works counterclockwise (cf. FIG. 3), but rather in the clockwise sense. As a result, the rotor is no longer in torque equilibrium and a resulting gravitational torque that acts clockwise is produced. As a result, the rotor 2 is set in rotational motion about the rotor axis. Again, it is pointed out that it is not mandatory to change the direction of the torque due to the first rotor blade 4′; a reduction of this torque starting from the situation according to FIG. 3 is usually sufficient to produce a sufficient gravitational torque to rotate the rotor 2.

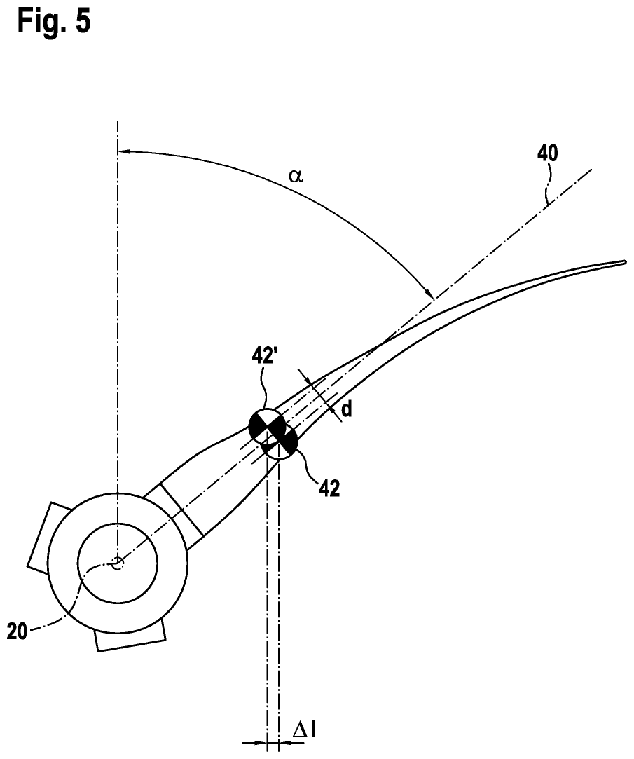

FIG. 5 shows schematically how the torque exerted on the rotor 2 by a rotor blade 4 can change as a function of the blade pitch angle. This torque results from the horizontal distance between the rotor axis 20 and the center of gravity 42, 42′ of the rotor blade 4. The horizontal distance or lever arm results initially from the angular position of the axis of rotation 40 of the rotor blade 4 relative to the 0° rotor angle, but is influenced by the relative position of the center of gravity 42, 42′ relative to the axis of rotation 40.

For illustrative purposes, two exemplary center of gravity positions are shown in FIG. 5, wherein the center of gravity 42 represents the position at a 90° blade pitch angle (i.e. in the feathered position), the center of gravity 42′ represents the position at a −90° blade pitch angle (i.e. in the negative feathered position). The two center of gravity positions are spaced apart from each other by a distance d of 40 cm—i.e. twice the distance between the centers of gravity 42, 42′ and the axis of rotation 40, which with a difference Δl of the lever arm leads to the calculation of the torque of d×cos α. Due to this possible change of the lever arm by the length Δl, a gravitational torque about the rotor axis 20 can be generated—if the change of the lever arm is not carried out similarly with the other rotor blades.

From the relationships shown in FIG. 5 it is further apparent that the influence of the blade pitch angle on the lever arm is very small for the torque in the region of the horizontal. In the embodiment shown, the change in torque due to adjusting the blade pitch angle in a range of +/−20° around the horizontal is very small, so that it has little or no influence on the gravitational torque.

In order to ensure that the gravitational torque generated on the rotor 2 by adjusting the different blade pitch angle of the first rotor blade 4′ always points in the same direction, even when the rotor 2 is rotating, the blade pitch angle must be different for a position of the rotor blade 4′ above the horizontal than if the rotor blade 4′ is below the horizontal.

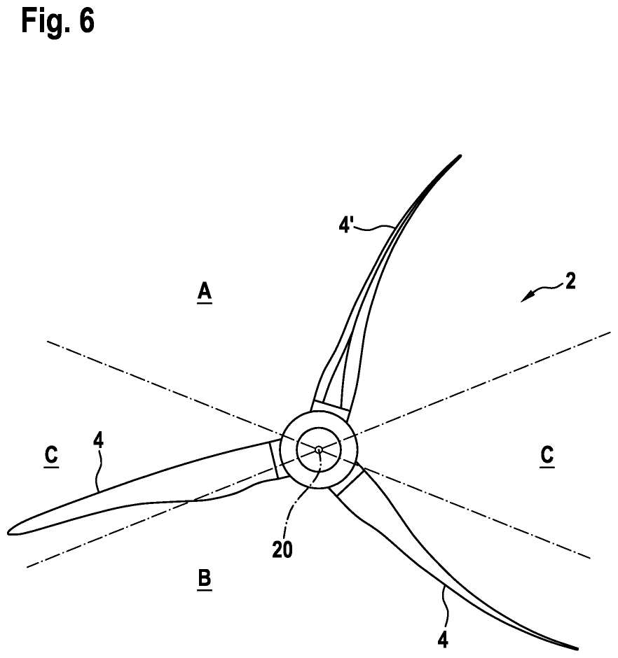

In FIG. 6, this situation is shown by way of example. For a constant clockwise rotation of the rotor 2, the blade pitch angle of the first rotor blade 4′ in the sector designated with “A” can be −90°, while in the sector designated with “B” it can then be +90°. Those sectors in the range of +/−20° around the horizontal that can be used to move the rotor blade 4′ between the +/−90° positions, in which, as explained, the blade pitch angle of a rotor blade 4′ has only a small influence on the torque applied to the rotor axis 20, are designated with “C” in FIG. 6.

In FIG. 6 it can also be seen that not only the blade pitch angle of the first rotor blade 4′ is systematically changed, but also those of the other rotor blades 4. If the other rotor blades 4 are also adjusted according to the stated specifications in the individual sectors A, B and C, the gravitational torque can be increased compared to the adjustment of only a single rotor blade 4′.

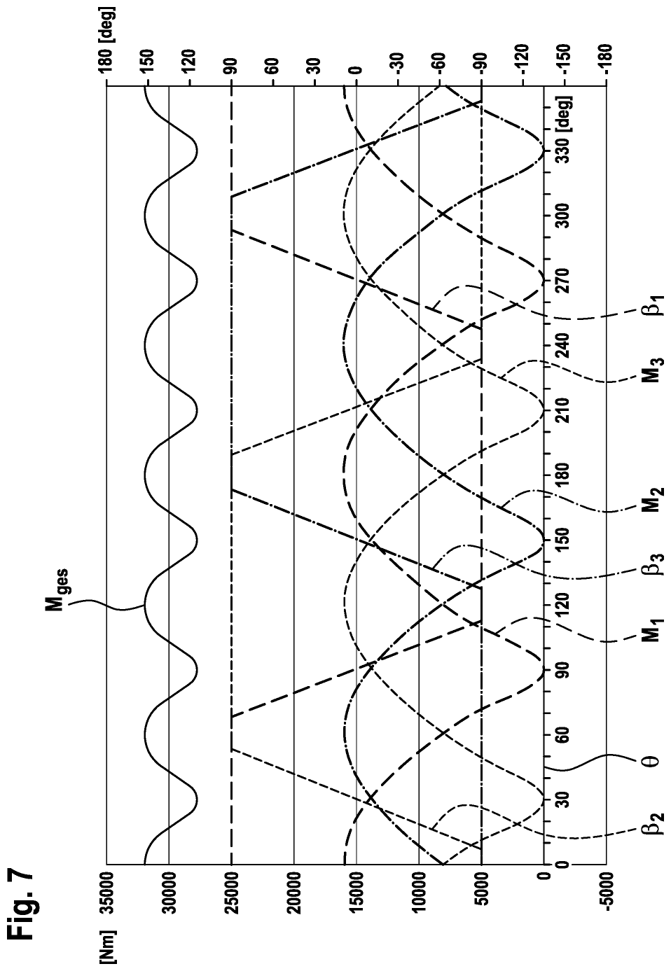

FIG. 7 shows by way of example the gravitational torque M_{ges} that can be achieved in the wind turbine 1 according to FIGS. 1 and 2 depending on the rotor angle θ if all the rotor blades 4, 4′ of a wind turbine 1 according to the sectors shown in FIG. 6 can be adjusted to blade angles β of +/−90°. Here, the first rotor blade (designated with index “1” in FIG. 7) points perpendicularly upwards at a rotor blade angle θ of 0°, while the second rotor blade (index “2”) is at 120° and the third rotor blade (index “3”) is at 240° (cf. FIG. 3). At 0°, the blade pitch angle of the first rotor blade β₁ is therefore +90°, while the blade pitch angles β₂, β₃ of the other two rotor blades are −90°. With the rotor 2 rotating, the rotor angle θ must change and the blade pitch angles ⊖₁, β₂, β₃ are adjusted according to FIG. 6 in order to always obtain the maximum gravitational torque M_{ges}.

FIG. 7 shows the torque components M₁, M₂, M₃ that the individual rotor blades 4, 4′ contribute to the gravitational torque M_{ges}. It can be seen from these components M₁,M₂,M₃ that the influence of a rotor blade 4, 4′ on the gravitational torque M_{ges} decreases whenever a rotor blade 4, 4′ approaches the horizontal. In just these areas (sector C in FIG. 6) the blade pitch angle β is moved from +90° to −90° or vice versa in each case.

With the method according to the invention, the rotor 2 of the wind turbine 1 can be moved in particular in still wind conditions. Also due to the different blade pitch angles of the individual rotor blades 4, 4′ during the process, which can lead to undesirable loads on the wind turbine, it is preferred if the control unit 16 only begins the process according to the invention when the device 15 for determining the wind speed measures a wind speed of less than 3 m/s, preferably of less than 2 m/s. The control unit 16 also terminates the process if the wind speed increases during said process to more than 3 m/s, preferably to more than 2 m/s. The control unit 16 also terminates the process if the rotor speed determined by the device 14 exceeds a predetermined maximum value. In both cases, the rotor blades 4, 4′ are moved to the feathered position, i.e. the 90° position.

The method according to the invention is particularly suitable for moving the rotor 2 to a desired angular position, for example to be able to carry out maintenance on the wind turbine 1. For this purpose, the current rotor angle detected by the device 13 is compared with the desired angular position and the rotor 2 is braked with the help of the brake 12 so that the rotor 2 comes to a standstill in the desired position. At the same time, the rotor blades 4 are placed in a low-load position, for example in the feathered position, in order to avoid an unnecessary load on the brake 12.

In practice, it has been shown that the deformation of the rotor blades due to their own weight in the gravitational field also has a non-negligible influence on the center of gravity displacements. In this respect, it is particularly preferable to take into account these elastic deformations when adjusting the blade angles. This can be done empirically or by computational simulation with a computational model that takes into account the gravitational deformation of the rotor blades in the gravitational field.

1. A method for rotating the rotor of a wind turbine having a rotor that is rotatable about a rotor axis said rotor comprising at least three rotor blades, the center of gravity of each of which lies outside a rotary axis for adjusting a blade pitch angle of the individual rotor blades wherein the blade pitch angle of a first rotor blade for creating an imbalance in the rotor is systematically set differently from the blade pitch angle of a second rotor blade so that a gravitational torque about the rotor axis is generated by changing the position of the center of gravity of the first rotor blade.

2. The method of claim 1, wherein the gravitational torque generated about the rotor axis is sufficient to overcome a breakaway torque existing in the drive train due to the frictional forces.

3. The method of claim 1, wherein the blade pitch angle of at least the first rotor blade is changed as a function of a rotor angle so that the imbalance resulting from the torque acts in a predetermined direction about the rotor axis.

4. The method of claim 1, wherein the axis of rotation for adjusting the blade pitch angle of the first rotor blade for generating an imbalance deviates from the horizontal by at least 5°, preferably by at least 10°, more preferably by at least 20°.

5. The method of claim 3, wherein the blade pitch angles of at least two, preferably of all rotor blades are changed as a function of the rotor angle so that the imbalance of the rotor is increased compared to the change in the angle of attack of only the first rotor blade.

6. The method of claim 3, wherein for moving the rotor to a predetermined angular position the rotor angle is monitored and the imbalance in the rotor is reduced or eliminated before or on reaching the predetermined angular position and/or the rotor is stopped in the specified angular position by a brake.

7. The method of claim 1, wherein before and/or during the execution of the method the wind speed at the wind turbine is monitored, and the method is terminated at wind speeds of more than 3 m/s, preferably more than 2 m/s, more preferably more than 1 m/s.

8. The method of claim 1, wherein before and/or during the execution of the method the rotational speed of the rotor is monitored and the method is terminated on exceeding a predetermined maximum speed.

9. The method of claim 1, wherein for eliminating the imbalance in the rotor and/or on terminating the process method, the blade pitch angle of the rotor blades are set as identical, preferably in the feathered position.

10. The method of claim 1, wherein electric blade adjustment actuators are provided for the adjustment of the blade pitch angle of the individual rotor blades.

11. The method of claim 1, wherein the rotor blades are pre-curved rotor blades.

12. A computer program product comprising program parts that are designed to perform the method claim 1 when loaded in a computer, preferably the control unit of a wind turbine.

13. A wind turbine with a rotor that is rotatable about a rotor axis, comprising at least three rotor blades, the center of gravity of each of which lies outside the axes of rotation for adjusting the blade pitch angles of the individual rotor blades, and a control unit, wherein the control unit is designed to carry out the method of claim 1.
